(19) United States
(12) Patent Application Publication
(10) Pub. No.: US 2009/0056350 A1
(43) Pub. Date: Mar. 5, 2009

(54) BIMETALLIC HEAT SINK AIR DEFLECTORS FOR DIRECTED AIRFLOW FOR IMPROVED THERMAL TRANSFER AND DISSIPATION

(75) Inventors: Philip R. Germann, Oronoco, MN (US); Don A. Gilliland, Rochester, MN (US); Cary M. Huettner, Rochester, MN (US); Mark J. Jeanson, Rochester, MN (US); George Zettles, Rochester, MN (US)

Correspondence Address: CANTOR COLBURN LLP - IBM ROCHESTER DIVISION, 20 Church Street, 22nd Floor, Hartford, CT, 06103, US

(73) Assignee: International Business Machine Corporation, Armonk, NY (US)

(21) Appl. No.: 11/846,301

(22) Filed: Aug. 28, 2007

(51) Int. Cl. F25B 49/00; G05D 23/02

(52) U.S. Cl. 62/132

(57) ABSTRACT

A cooling apparatus, includes: one or more bimetallic deflectors attached to a mounting post, the mounting post configured for mating engagement with a protrusion of a heat sink, such that the one or more bimetallic deflectors are in thermal contact with the protrusion when the mounting post is engaged therewith; wherein the bimetallic deflectors are configured to deflect in response to thermal energy conducted from the protrusions so as to change a direction of airflow incident thereupon.

### BACKGROUND OF THE INVENTION

1. Field of the Invention

This invention relates generally to thermal heat sinking and more particularly to a method, apparatus, and system for bimetallic heat sink air deflectors for directed airflow for improved thermal dissipation and thermal transfer.

2. Description of the Related Art

Bimetallic materials convert temperature changes into mechanical displacement. FIG. 1 illustrates a bimetallic material 100 that generally consists of two strips of different metals (102, 104) with differing coefficients of thermal expansion (CTE), which expand at different rates as they are heated, usually steel and copper. The strips are joined together throughout their length by rivets, by brazing or by welding (signified by bands 106). The different expansions force the flat strip to bend one way if heated, and in the opposite direction if cooled below its normal temperature. The metal with the higher expansion is on the outer side of the curve when the strip is heated and on the inner side when cooled. The sideways displacement (signified by arrow 108) of the bimetallic strip is much larger than the small lengthways expansion 110 in either of the two metals. This effect is used in a range of mechanical and electrical devices. In some applications the bi-metal strip is used in the flat form. In others, it is wrapped into a coil for compactness. The greater length of the coiled version provides improved sensitivity.

Heat sinks absorb and dissipate heat from a source of heat using thermal contact, which is either direct or radiant. In operation, electronic components generate heat that requires thermal dissipation. The elevated operating temperatures of electronic components adversely affect their performance, operating efficiency, and expected useable life. Therefore, heat sinks are employed to dissipate the heat generated by the electronic components.

Heat sinks function by efficiently transferring thermal energy (heat) from an object at high temperature to a second object at a lower temperature with a much greater heat capacity. Heat capacity is a measure of the heat energy required to increase the temperature of an object by a certain temperature interval. The transfer of thermal energy brings the first object into thermal equilibrium with the second, lowering the temperature of the first object, fulfilling the heat sink's role as a cooling device. Efficient function of a heat sink relies on rapid transfer of thermal energy from the first object to the heat sink, and the heat sink to the second object.

The most common design for heat sinks are metal devices with a flat interface surface and many fins or pins protruding from the underside of the interface surface. Objects requiring thermal cooling are mated and secured to the interface surface. The high thermal conductivity of the heat sink metal combined with the increased surface area provided by the protrusions result in the rapid transfer of thermal energy to the surrounding, cooler, air, thereby cooling the heat sink and whatever it is in direct thermal contact with the heat sink.

### SUMMARY OF THE INVENTION

Embodiments of the present invention include an apparatus, system, and method for utilizing bimetallic material to direct airflow in a heat sink structure, the apparatus includes: one or more bimetallic deflectors attached to a mounting post, the mounting post configured for mating engagement with a protrusion of a heat sink, such that the one or more bimetallic deflectors are in thermal contact with the protrusion when the mounting post is engaged therewith; wherein the bimetallic deflectors are configured to deflect in response to thermal energy conducted from the protrusions so as to change a direction of airflow incident thereupon.

A cooling system, the system includes: a heat sink having a plurality of protrusions; one or more mounting posts mated to one or more of the plurality of protrusions; each of the one or more mounting posts having one or more bimetallic deflectors attached thereto, such that the one or more bimetallic deflectors are in thermal contact with a corresponding one of the protrusions; wherein the bimetallic deflectors are configured to deflect in response to thermal energy conducted from the protrusions so as to change a direction of airflow incident thereupon.

A method for directing airflow in a heat sink structure, the method includes: attaching one or more bimetallic deflectors to a mounting post; and mating the mounting post to a protrusion of a heat sink, such that the one or more bimetallic deflectors are in thermal contact with the protrusion; wherein the bimetallic deflectors are configured to deflect in response to thermal energy conducted from the protrusions so as to change a direction of airflow incident thereupon.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a method and apparatus for bimetallic heat sink air deflectors for directed airflow for improved thermal dissipation and thermal transfer. The present invention utilizes bimetallic materials attached to protrusions on a heat sink to direct airflow to hotspots for the optimal cooling of the hotspots on the heat sink.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a side view of a bimetallic material and illustrates bimetallic behavior at room temperature and at an elevated temperature.

FIG. 2A illustrates a perspective view of a pin-wing bimetallic deflector according to an embodiment of the invention.

FIG. 2B illustrates a perspective view of the pin-wing bimetallic deflector of FIG. 2A in a deflection position according to embodiments of the invention.

FIG. 3A illustrates a partial perspective view of a series of pin-wing bimetallic deflectors attached to an array of heat sink pins according to an embodiment of the invention.

FIG. 3B illustrates a partial perspective view of the series of pin-wing bimetallic deflectors attached to the array of heat sink pins of FIG. 4 in a deflection state according to an embodiment of the invention.

FIG. 3C illustrates a partial perspective view of the pin-wing bimetallic deflector configuration of FIGS. 3A and 3B with a passive fence introduced to the array of heat sink pins according to an embodiment of the invention.

FIG. 4A illustrates a partial perspective view of a series of half pin-wing bimetallic deflectors attached to heat sink fins according to an embodiment of the invention.

FIG. 4B illustrates a partial perspective view of a series of half pin-wing bimetallic deflectors of FIG. 4A in a deflection state attached to heat sink fins according to an embodiment of the invention.

FIGS. 5A and 5B illustrate perspective views of a bimetallic helix structure, which rotates with changes in temperature according to an embodiment of the invention.

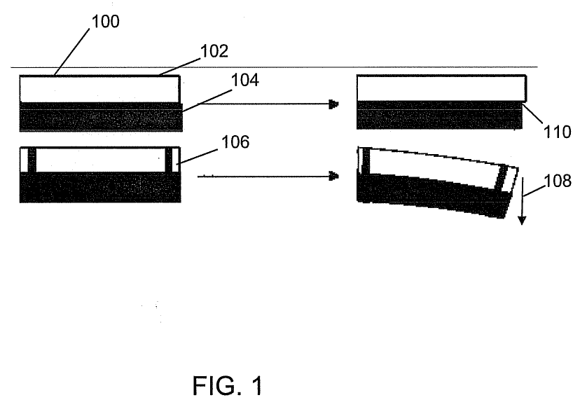

The detailed description explains the preferred embodiments of the invention, together with advantages and features, by way of example with reference to the drawings.

### DETAILED DESCRIPTION

Embodiments of the invention provide a means for a method, apparatus, and system for employing bimetallic deflectors in a heat sink structure. The bimetallic deflectors direct airflow for improved thermal dissipation and thermal transfer in a heat sink structure. Embodiments of the present invention utilize bimetallic materials attached to protrusions on a heat sink to direct airflow to hotspots, for the optimal cooling of the hotspots on a heat sink. The bimetallic deflectors of embodiments of the present invention act to direct incoming airflow to areas that can best utilize the heat transfer. For example, a component such as a central processing unit (CPU), radio frequency (RF) transistor, transformer, memory, etc. that requires cooling has airflow directed towards it as its temperature rises. If the operating temperature declines or usage of the part diminishes or stops, the airflow is directed to another portion of the heat sink by the bimetallic deflectors of embodiments of the invention.

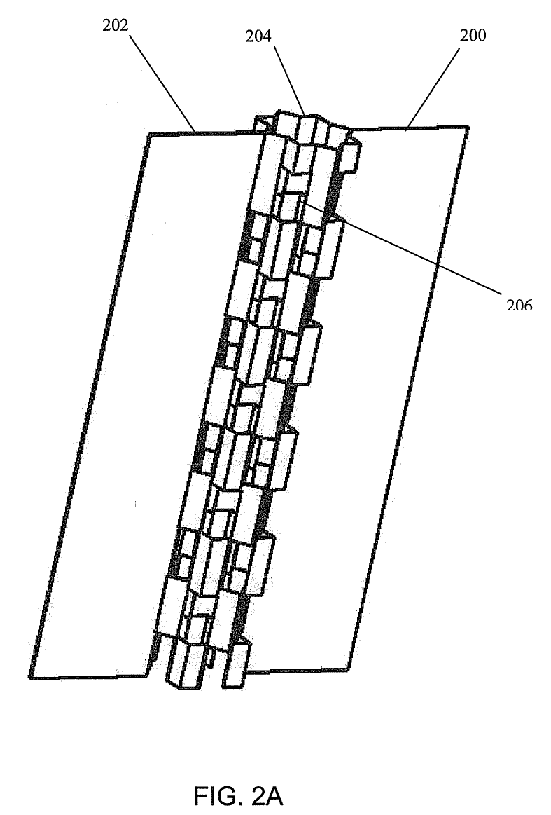

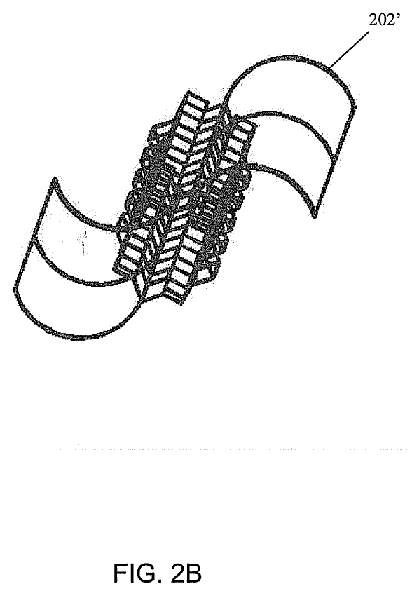

FIGS. 2A and 2B illustrate perspective views of a pin-wing bimetallic deflector 200 according to an embodiment of the invention. A set of bimetallic deflector wings 202 is attached to a slip-on mounting post 204. The slip-on mounting post 204 is designed to mate with protrusions from the heat sink, such as pins or pillars. The slip-on mounting posts 204 have vents 206 that are configured to allow air to circulate though the slip-on mounting post 204 to the heat sink protrusions. The slip-on mounting posts 204 are formed with heat conducting materials, so as to conduct heat to the bimetallic wings 202.

As heat increases across the vented slip-on mounting post 204, the heat is transferred by conduction to the bimetallic wings 202. The bimetallic wings 202 begin to deflect as they heat up, as seen in FIG. 2B as 202′. The deflection of the bimetallic wings 202′ change the direction of airflow across the heat sink. When the bimetallic wings 202′ begin to cool, they return to their original position 202.

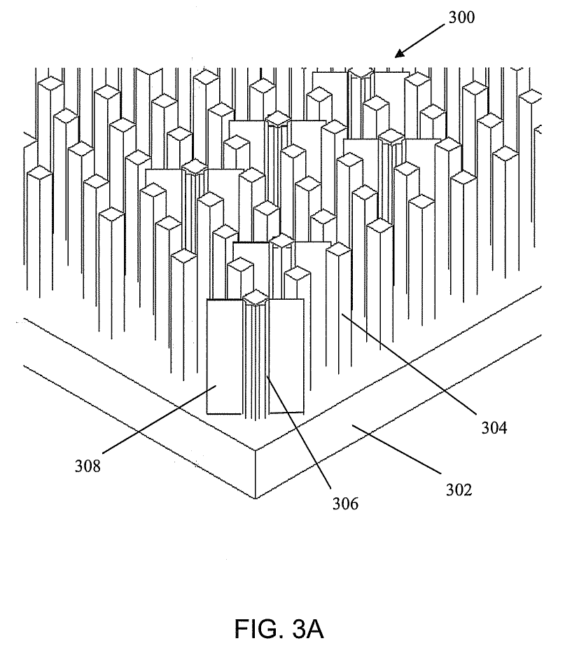

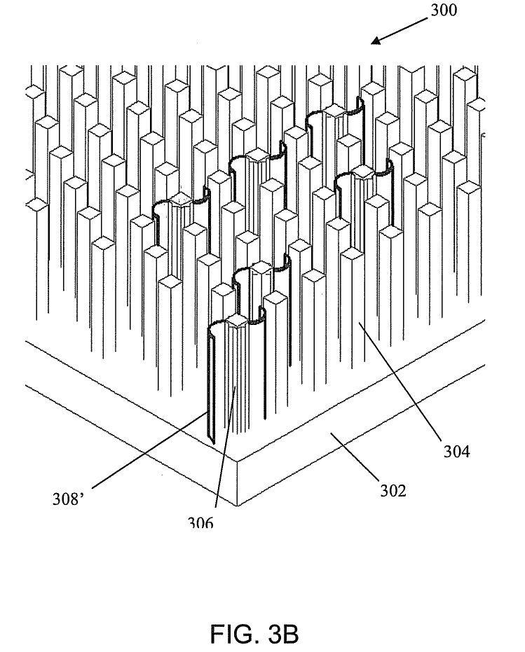

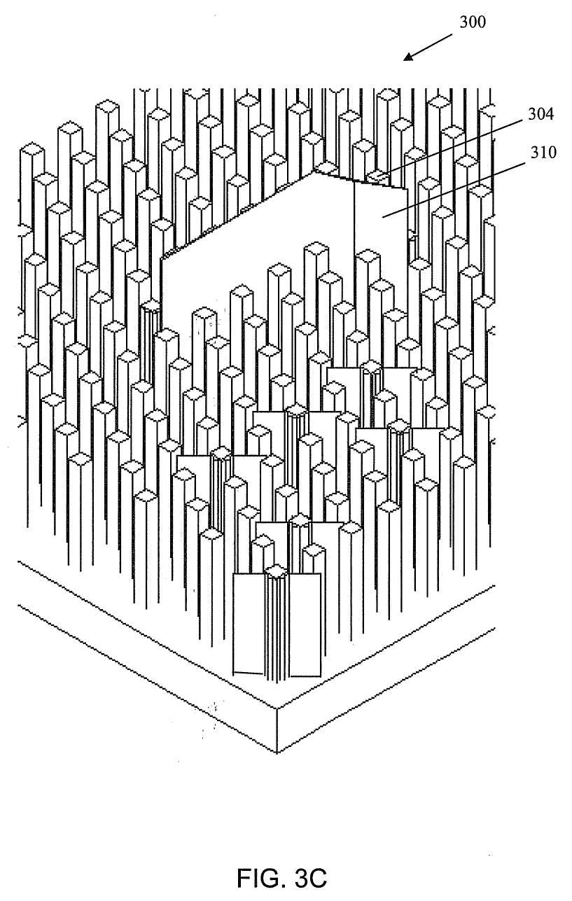

FIGS. 3A-3C illustrate a partial perspective view of a heat sink 300 with a series of pin-wing bimetallic deflectors 306 attached to an array of heat sink pins 304 protruding from a base 302 according to an embodiment of the invention. The bimetallic wings 308 may be positioned at a multiple of 45 degrees relative to the heat sink pins 304. In FIG. 3B the bimetallic wings 308, deflect to 308′ as they heat up, thereby altering the airflow. In FIG. 3C, for large “semi-permanent” air deflection, a passive “fence” 310 may be placed onto the heat sink pins 304.

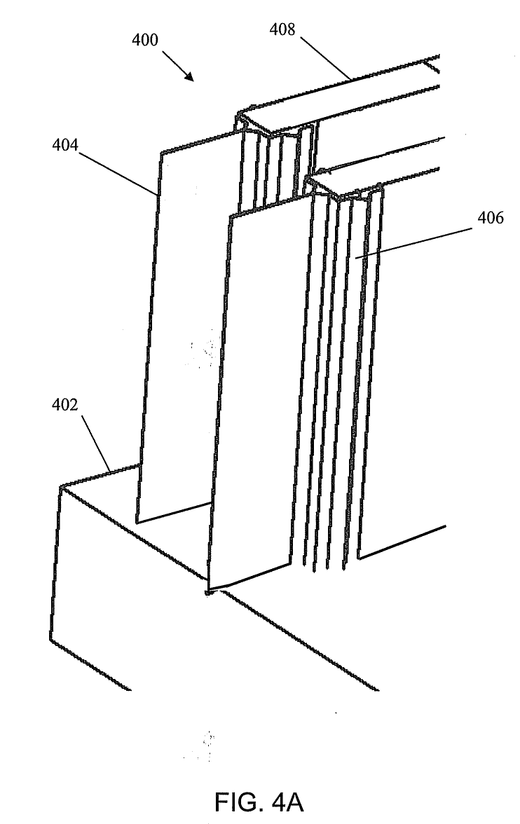

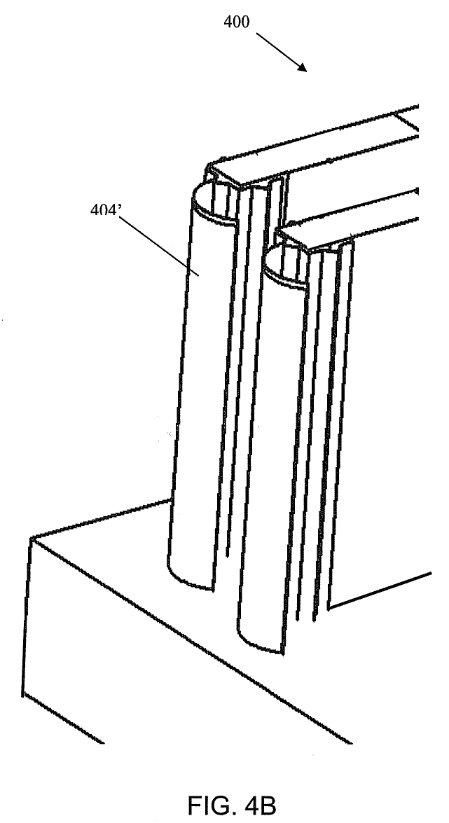

FIGS. 4A and 4B illustrate a partial perspective view of a heat sink 400 with a series of half pin-wing bimetallic deflectors 406 attached to heat sink fins 408 protruding from a heat sink base 402 according to an embodiment of the invention. As the bimetallic wings 404 begin to heat up, the bimetallic wings 404 deflect to the position seen in FIG. 4B as bimetallic wings 404′.

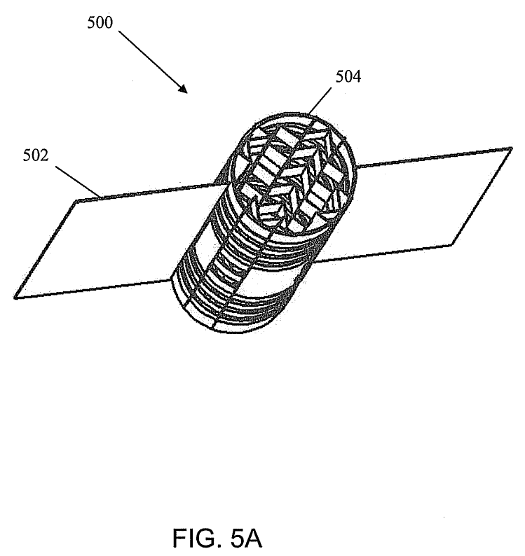

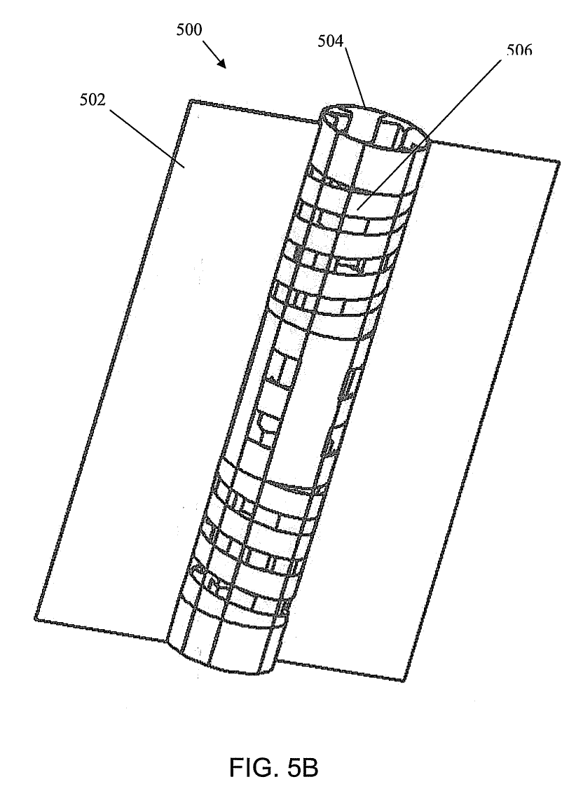

FIGS. 5A and 5B illustrate perspective views of a bimetallic helix structure 500 that rotates with changes in temperature according to an embodiment of the invention. The bimetallic helix structure 500 may offer additional rotation of the deflector wings or vanes 502 (which are not bimetallic) than the previous embodiments. The bimetallic wings of the previous embodiments, in certain instances, may be too thin to provide sufficient deflection. The bimetallic helix structure 500 has a core sleeve 504 with a helix spiral of bimetallic material 506 that may be used to increase the rotation of wings or vanes 502. The core sleeve 504 has opposing bimetallic strips in the helix spiral 506 to maintain a centered position of the core sleeve 504 around a heat sink pin, column, or pillar.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A cooling apparatus, comprising:
one or more bimetallic deflectors attached to a mounting post, the mounting post configured for mating engagement with a protrusion of a heat sink, such that the one or more bimetallic deflectors are in thermal contact with the protrusion when the mounting post is engaged therewith;
wherein the bimetallic deflectors are configured to deflect in response to thermal energy conducted from the protrusions so as to change a direction of airflow incident thereupon.

2. The apparatus of claim 1, wherein the protrusion comprises one or more of a pin, a pillar, a column, and a fin.

3. The apparatus of claim 1, wherein the one or more bimetallic deflectors are joined to the protrusion at multiples of 45 degrees.

4. The apparatus of claim 1, wherein the mounting post further comprises a slip-on mounting post having one or more vents configured to allow air to circulate to the heat sink protrusion.

5. The apparatus of claim 4, wherein the slip-on mounting post is formed with one or more heat conducting materials, so as to conduct heat to the bimetallic deflectors.

6. The apparatus of claim 4, wherein the slip-on mounting post is formed with a helix structure having a spiral of bimetallic material that rotates the entire helix structure in response to the heating of the heat sink protrusion.

7. A cooling system, the system comprising:
a heat sink having a plurality of protrusions;
one or more mounting posts mated to one or more of the plurality of protrusions;
each of the one or more mounting posts having one or more bimetallic deflectors attached thereto, such that the one or more bimetallic deflectors are in thermal contact with a corresponding one of the protrusions; and
wherein the bimetallic deflectors are configured to deflect in response to thermal energy conducted from the protrusions so as to change a direction of airflow incident thereupon.

8. The system of claim 7, wherein the protrusions comprise one or more of pins, pillars, columns, and fins.

9. The system of claim 7, wherein the one or more bimetallic deflectors are joined to the one or more protrusions at multiples of 45 degrees.

10. The system of claim 7, wherein the one or more mounting posts further comprise slip-on mounting posts having one or more vents configured to allow air to circulate to the heat sink protrusions.

11. The system of claim 10, wherein the slip-on mounting posts are formed with one or more heat conducting materials, so as to conduct heat to the bimetallic deflectors.

12. The system of claim 10, wherein the slip-on mounting post is formed with a helix structure with a spiral of bimetallic material that rotates the entire helix structure in response to the heating of the heat sink protrusions.

13. A method for directing airflow in a heat sink structure, the method comprising:
attaching one or more bimetallic deflectors to a mounting post; and
mating the mounting post to a protrusion of a heat sink, such that the one or more bimetallic deflectors are in thermal contact with the protrusion;
wherein the bimetallic deflectors are configured to deflect in response to thermal energy conducted from the protrusions so as to change a direction of airflow incident thereupon.

14. The method of claim 13, wherein the protrusion comprises one or more of a pin, a pillar, a column, and a fin.

15. The method of claim 13, wherein the one or more bimetallic deflectors are joined to the protrusion at multiples of 45 degrees.

16. The method of claim 13, wherein the mounting post further comprises a slip-on mounting post having one or more vents configured to allow air to circulate to the heat sink protrusion.

17. The method of claim 16, wherein the slip-on mounting post is formed with one or more heat conducting materials, so as to conduct heat to the bimetallic deflectors.

18. The method of claim 16, wherein the slip-on mounting post is formed with a helix structure with a spiral of bimetallic material that rotates the entire helix structure in response to the heating of the heat sink protrusions.
